(19) United States
(12) Patent Application Publication
(10) Pub. No.: US 2008/0107939 A1
(43) Pub. Date: May 8, 2008

(54) Fuel Cell System

(76) Inventors: Hitoshi Hamada, Shizuoka-ken (JP); Shigeru Ogino, Aichi-ken (JP)

Correspondence Address: KENYON & KENYON LLP, 1500 K STREET N.W., SUITE 700, WASHINGTON, DC, 20005, US

(21) Appl. No.: 11/886,009

(22) PCT Filed: Mar. 29, 2006
(86) PCT No.: PCT/JP06/07154

§ 371 Date: Sep. 10, 2007

(30) Foreign Application Priority Data
Mar. 29, 2005 (JP) 2005-096426
Mar. 29, 2005 (JP) 2005-096428

(51) Int. Cl. H01M 8/04

(52) U.S. Cl. 429/22; 429/12; 429/34

(57) ABSTRACT

A fuel cell system, in particular, improvement to a fuel cell system intended to enhance the drainage of generation water produced during power generation and to maintain and stabilize the power generation efficiency of fuel cell. Monitor keeps watch over the state of use of FC stack and upon judging that the drainage of reaction water falls into arrears in a gas flow passage to result in drain clogging, not only estimates the amount of reaction water but also computes the amount of drainage maintenance agent to be added in conformity with the amount of reaction water discharged, instructing flow rate controller to feed the required amount of water repellent agent from water repellent agent storage tank. Pursuant to the instruction from the monitor, the flow rate controller feeds the required amount of water repellent agent from the water repellent agent storage tank to the mixed supply unit. The oxidizing gas is supplied to the mixed supply unit from the cathode-side pump, and the water repellent agent and the oxidizing gas are then mixed together within the mixed supply unit and supplied to the oxidizing gas supply passages within the FC stack. The reaction water, water repellent agent and discharged oxidizing gas that are discharged from the oxidizing gas discharge passage of the FC stack are separated into the water repellent agent and a mixture of reaction water and discharged oxidizing gas by the recovery unit and the water repellent agent is then recovered.

### TECHNICAL FIELD

The present invention relates to a fuel cell system, and in particular to a fuel cell system that improves the drainage of reaction water generated during power generation, and maintains and stabilizes the power generation efficiency of the fuel cell.

### BACKGROUND ART

As shown in FIG. 14, in a solid polymer fuel cell, an assembly (MEA: Membrane Electrode Assembly) comprising an electrolyte film 52 formed from a solid polymer film sandwiched between two electrodes, namely a fuel electrode 50 and an air electrode 54, is itself sandwiched between two separators 30 to generate a cell that functions as the smallest unit, and a plurality of these cells are then usually stacked to form a fuel cell stack (FC stack), enabling a high voltage to be obtained.

The mechanism for power generation by a solid polymer fuel cell generally involves the supply of a fuel gas such as a hydrogen-containing gas to the fuel electrode (the anode side electrode) 50, and supply of an oxidizing gas such as a gas comprising mainly oxygen (O₂) or air to the air electrode (the cathode side electrode) 54. The hydrogen-containing gas is supplied to the fuel electrode 50 via fine passages formed in the surfaces of the separators 30, and the action of the electrode catalyst causes the hydrogen to dissociate into electrons and hydrogen ions (H⁺). The electrons flow through an external circuit from the fuel electrode 50 to the air electrode 54, thereby generating an electrical current. Meanwhile, the hydrogen ions (H⁺) pass through the electrolyte film 52 to the air electrode 54, and bond with oxygen and the electrons that have passed through the external circuit, thereby generating reaction water (H₂O). The heat that is generated at the same time as the bonding reaction between hydrogen (H₂), oxygen (O₂) and the electrons is recovered using cooling water. Furthermore, the water generated at the air electrode 54 on the cathode side of the assembly (hereafter referred to as “reaction water”) is discharged from the cathode side.

As shown in FIG. 14, during operation of the fuel cell (during power generation), reaction water is generated at those portions on the surface of the air electrode 54 that are in contact with the electrolyte film 52. As the fuel cell is operated, if this reaction water is unable to be efficiently discharged from the fuel cell system, then reaction water accumulates within the space between the diffusion layer of the air electrode 54 and the separator 30, and as a result, diffusion of the reaction gases and particularly the oxidizing gas is inhibited, causing a so-called flatting phenomenon. In such cases, a reduction in the power generation efficiency of the fuel cell tends to be observed.

Accordingly, a number of devices have been proposed for efficiently discharging the reaction water from fuel cells. For example, Japanese Patent Laid-Open Publication No. 2000-251903 proposes providing a coating layer, and in particular a hydrophilic polymer layer, which exhibits a contact angle with water of not more than 40 degrees, on the surface of a separator molding of the fuel cell, Japanese Patent Laid-Open Publication No. 2003-142116 proposes irradiating vacuum ultraviolet light onto the surface of a fuel cell separator composed mainly of carbon, thereby improving the wetting properties of the separator surface, and Japanese Patent Laid-Open Publication No. 2003-213563 proposes a fuel cell that uses, as an electrode, a carbon fiber electrode material having a layer composed of a water repellent resin and conductive fine particles on one surface of the material, wherein the contact angle with water at this surface is at least 108 degrees.

However, in the separators proposed in Japanese Patent Laid-Open Publication No. 2000-251903 and Japanese Patent Laid-Open Publication No. 2003-142116, as the operation time of the fuel cell increases, the hydrophilic surface is gradually removed by the action of the reaction water, and as a result, the hydrophilic action of the surface gradually deteriorates, meaning maintaining the drainage properties of the fuel cell over an extended period is problematic. Furthermore, the carbon fiber electrode material proposed in Japanese Patent Laid-Open Publication No. 2003-213563 also suffers from a gradual degradation of the water repellent resin on the electrode surface as the fuel cell is operated, meaning that in a similar manner to above, maintaining the drainage properties of the fuel cell over an extended period is problematic.

On the other hand, Japanese Patent Laid-Open Publication No. Hei 07-307161 proposes an operation method for a fuel cell, wherein during operation of a phosphoric acid fuel cell, if the cell output properties deteriorate as a result of excessive wetting of the catalyst layer of the cathode side electrode, then as shown in FIG. 15, a comparison is made between the unit cell voltage and a previously set limit (S200), and when the operating voltage of the unit cell falls below this limit, the reduction in the cell output properties is deemed to be due to excessive wetting of the catalyst layer of the cathode side electrode, and operation of the fuel cell is temporarily halted with the fuel cell still in a raised-temperature state (S202), supply of the oxidizing gas to the cathode side electrode is halted, and supply of nitrogen gas to the cathode side electrode is then started, thereby purging residual oxygen components of the oxidizing gas from the cathode side electrode (S204), and following adequate purging of the cathode side electrode with nitrogen gas, supply of hydrogen gas, which functions as a hydrophilic functional group-removing gas, is started, thereby conducting a hydrogen reduction treatment of the cathode side electrode (S206), hydrophilic functional groups generated at the surface of the carbon carrier within the cathode side electrode catalyst layer are reduced and removed, and the supply of nitrogen gas to the cathode side electrode is then re-started, thereby purging any residual hydrophilic functional group-removing hydrogen gas from the cathode side electrode (S208), and operation of the fuel cell is then recommenced (S210).

However, in the operation method for a fuel cell proposed in the above Japanese Patent Laid-Open Publication No. Hei 07-307161, operation of the fuel cell must be halted when required in order to improve the wetting properties of the catalyst layer of the cathode side electrode, meaning there is a possibility of a significant loss in the operating efficiency of the fuel cell. Moreover, in those cases where hydrogen is used as the hydrophilic functional group-removing gas, this hydrogen gas must be thoroughly eliminated from the oxidizing gas passages by purging with nitrogen gas in order to avoid encounters between the hydrogen gas and the oxidizing gas that is supplied upon recommencement of operation, but this process further lengthens the time for which operation is halted, meaning there is a possibility that the operating efficiency of the fuel cell may deteriorate even further.

### DISCLOSURE OF INVENTION

In light of the problems outlined above, it is an advantage of the present invention to provide a fuel cell system that enables favorable discharge of reaction water from the fuel electrode, and maintains and stabilizes the operating efficiency of the fuel cell.

The fuel cell system of the present invention has the features described below.

(1) A fuel cell system having a fuel cell formed by stacking cells, each composed of an assembly having a fuel electrode and an air electrode on an electrolyte film, and a pair of separators that sandwich the assembly, wherein the fuel cell has a drainage additive supply unit that supplies a drainage additive for improving the drainage properties within the cell.

(2) A fuel cell system, comprising a fuel cell formed by stacking cells, each composed of an assembly having a fuel electrode and an air electrode on an electrolyte film, and a pair of separators that sandwich the assembly, and a reaction gas supply unit that supplies a reaction gas to the fuel cell, wherein the system also has a drainage additive supply unit that supplies a drainage additive for improving the drainage properties within the cell to the reaction gas supplied by the reaction gas supply unit.

By using the above drainage additive, reaction water within the cells can be discharged efficiently from the fuel cell without halting the operation of the fuel cell, and therefore the flatting phenomenon is unlikely to occur, and the output properties of the fuel cell can be maintained and stabilized.

(3) The fuel cell system disclosed in either (1) or (2) above, further comprising a monitor that monitors the usage state of the fuel cell, wherein the drainage additive is supplied to the fuel cell by the drainage additive supply unit in accordance with the usage state of the fuel cell detected by the monitor.

(4) The fuel cell system disclosed in any one of (1) through (3) above, further comprising an exhaust gas passage that carries exhaust gas discharged from the fuel cell, and a recovery unit that is provided within the exhaust gas passage and recovers the drainage additive.

(5) The fuel cell system disclosed in any one of (1) through (4) above, wherein the drainage additive supply unit supplies the drainage additive to the cathode side where the air electrode is located.

(6) A fuel cell system having a fuel cell formed by stacking cells, each composed of an assembly having a fuel electrode and an air electrode on an electrolyte film, and a pair of separators that sandwich the assembly, wherein the fuel cell has a drainage maintenance agent supply unit that supplies a drainage maintenance agent for maintaining the drainage properties within the cell.

In this configuration, by using the above drainage maintenance agent, reaction water within the cell can be discharged efficiently from the fuel cell without halting the operation of the fuel cell, and therefore the flatting phenomenon is unlikely to occur, and the output properties of the fuel cell can be maintained and stabilized.

(7) A fuel cell system, comprising a fuel cell formed by stacking cells, each composed of an assembly having a fuel electrode and an air electrode on an electrolyte film, and a pair of separators that sandwich the assembly, and a reaction gas supply unit that supplies a reaction gas to the fuel cell, wherein the system also has a drainage maintenance agent supply unit that supplies a drainage maintenance agent for maintaining the drainage properties within the cell to the reaction gas supplied by the reaction gas supply unit.

By supplying the drainage maintenance agent to the reaction gas and thereby supplying the drainage maintenance agent into the interior of the fuel cell together with the reaction gas, the diffusion of the reaction gas enables the drainage maintenance agent to also diffuse uniformly across the electrode diffusion layer surface and the separator surface. As a result, discharge of reaction water that exists on the electrode diffusion layer surface and the separator surface is accelerated, meaning any reduction in the output properties of the fuel cell can be suppressed.

(8) The fuel cell system disclosed in either (6) or (7) above, further comprising a monitor that monitors the usage state of the fuel cell, wherein the drainage maintenance agent is supplied to the fuel cell by the drainage maintenance agent supply unit in accordance with the usage state of the fuel cell detected by the monitor.

By monitoring the usage state of the fuel cell with the above monitor, the wetting of the electrode diffusion layer surface and the separator surface within the cells of the fuel cell can be ascertained. Consequently, in those cases where excessive wetting indicates that discharge of the reaction water is lagging, a suitable quantity of the drainage maintenance agent can be supplied to the fuel cell, meaning the wetting properties can be maintained at a favorable level, allowing the output properties of the fuel cell to be maintained and stabilized.

(9) The fuel cell system disclosed in any one of (6) through (8) above, further comprising an exhaust gas passage that carries exhaust gas discharged from the fuel cell, and a recovery unit that is provided within the exhaust gas passage and recovers the drainage maintenance agent.

Recovering the drainage maintenance agent enables the agent to be reused, meaning a fuel cell system that enables more efficient cost reductions can be provided.

(10) The fuel cell system disclosed in any one of (6) through (9) above, wherein the drainage maintenance agent is a surface tension reduction agent that reduces the surface tension of the reaction water generated within the cells.

Generally, the separator surface exhibits a high level of hydrophobicity, meaning the reaction water adheres to the surface and is difficult to discharge. Accordingly, by supplying a surface tension reduction agent that reduces the surface tension of the reaction water to the fuel cell, the contact angle between the separator and the reaction water accumulated on the separator surface is reduced, enabling the reaction water to be discharged more efficiently.

(11) The fuel cell system disclosed in (10) above, wherein the surface tension reduction agent is at least one reagent selected from the group consisting of alcohols and surfactants.

The above surface tension reduction agents dissolve readily in the reaction water, can effectively reduce the surface tension of the reaction water, and are more environmentally friendly than organic solvents.

(12) The fuel cell system disclosed in any one of (6) through (11) above, wherein the drainage maintenance agent supply unit supplies the drainage maintenance agent to the cathode side where the air electrode is located.

As described above, in the cells of the fuel cell, reaction water is generated at the cathode side. Accordingly, by supplying the drainage maintenance agent to the cathode side, the reaction water can be discharged efficiently.

(13) A fuel cell system, comprising a fuel cell formed by stacking cells, each composed of an assembly having a fuel electrode and an air electrode on an electrolyte film, and a pair of separators that sandwich the assembly, and a reaction gas supply passage that supplies a reaction gas to the fuel cell, wherein the system also has a water repellent agent supply unit that supplies a water repellent agent into the reaction gas supply passage provided within the cells of the fuel cell in order to impart the reaction gas supply passage with water repellency.

By supplying the water repellent agent to the reaction gas, thereby supplying the water repellent agent into the interior of the fuel cell together with the reaction gas, the diffusion of the reaction gas enables the water repellent agent to also diffuse uniformly across the electrode diffusion layer and catalyst layer. As a result, the water repellency performance of the electrode diffusion layer and catalyst layer within the cells can be maintained without halting the operation of the fuel cell, and therefore there is no possibility of a reduction in the diffusion efficiency of the reaction gas, occurrence of the flatting phenomenon is unlikely, and the output properties of the fuel cell can be maintained and stabilized.

(14) The fuel cell system disclosed in (13) above, wherein the water repellent agent is at least one material selected from the group consisting of saturated fatty acids, unsaturated fatty acids, silicon resin powders, paraffins, waxes, fluororesin powders, and creosote oils.

The above water repellent agents do not undergo reaction with the reaction gas, exhibit a superior water repellency function, and are readily adsorbed to the electrodes within the fuel cell, meaning the water repellency performance of the electrode diffusion layer and catalyst layer within the cells can be satisfactorily maintained.

(15) The fuel cell system disclosed in either (13) or (14) above, wherein the water repellent agent supply unit supplies the water repellent agent to the cathode side where the air electrode is located.

As described above, in the cells of the fuel cell, reaction water is generated at the cathode side. Accordingly, by supplying the water repellent agent to the cathode side, the reaction water can be discharged efficiently, and excessive wetting of the electrode diffusion layer and catalyst layer can be prevented.

(16) The fuel cell system disclosed in any one of (13) through (15) above, further comprising an exhaust gas passage that carries exhaust gas discharged from the fuel cell, and a trapping unit that is provided within the exhaust gas passage and traps the water repellent agent.

Trapping and recovering the water repellent agent enables the agent to be reused, meaning a fuel cell system that enables more efficient cost reductions can be provided.

(17) The fuel cell system disclosed in anyone of (13) through (15) above, further comprising an exhaust gas passage that carries exhaust gas discharged from the fuel cell, a first trapping unit that is provided within the exhaust gas passage and traps the water repellent agent, a second trapping unit that is provided within the reaction gas supply passage and is capable of trapping the water repellent agent, and a gas passage switching unit which, based on the quantities trapped by the first trapping unit and the second trapping unit, selects and then switches the supply passage for the reaction gas to either one of the reaction gas supply passage and the exhaust gas passage.

By employing this configuration, the water repellent agent trapped by the first and second trapping units can be re-supplied to the fuel cell together with the reaction gas, and consequently replenishment of the water repellent agent can be suppressed to a minimum, and a fuel cell system that enables more efficient cost reductions can be provided.

### BRIEF DESCRIPTION OF THE DRAWINGS

FIG. 1 is a block diagram showing the structure of a first embodiment of a fuel cell system according to the present invention.

FIG. 2 is a block diagram showing the structure of a second embodiment of a fuel cell system according to the present invention.

FIG. 3 is a flowchart describing one example of the supply operation for a drainage maintenance agent within a fuel cell system according to the present invention.

FIG. 4 is a diagram describing the change in the water contact angle relative to a separator and a diffusion layer, from the state prior to addition of a drainage maintenance agent to the state following addition.

FIG. 5 is a diagram describing the structure of one example of an oxidizing gas supply unit of a fuel cell system according to the present invention.

FIG. 6 is a diagram describing the structure of another example of an oxidizing gas supply unit of a fuel cell system according to the present invention.

FIG. 7 is a diagram describing the structure of yet another example of an oxidizing gas supply unit of a fuel cell system according to the present invention.

FIG. 8 is a block diagram showing the structure of a third embodiment of a fuel cell system according to the present invention.

FIG. 9 is a flowchart describing one example of the supply operation for a water repellent agent within the fuel cell system of the structure shown in FIG. 8.

FIG. 10 is a block diagram showing the structure of a fourth embodiment of a fuel cell system according to the present invention.

FIG. 11 is a flowchart describing one example of the supply operation for a water repellent agent within the fuel cell system shown in FIG. 10.

FIG. 12 is a diagram describing the change in the water contact angle relative to a gas diffusion layer, from the state prior to addition of a water repellent agent to the state following addition.

FIG. 13 is a diagram describing the structure of one example of mixed supply unit of a fuel cell system according to the present invention.

FIG. 14 is a diagram describing the structure of a cell within a fuel cell, and the mechanism during power generation.

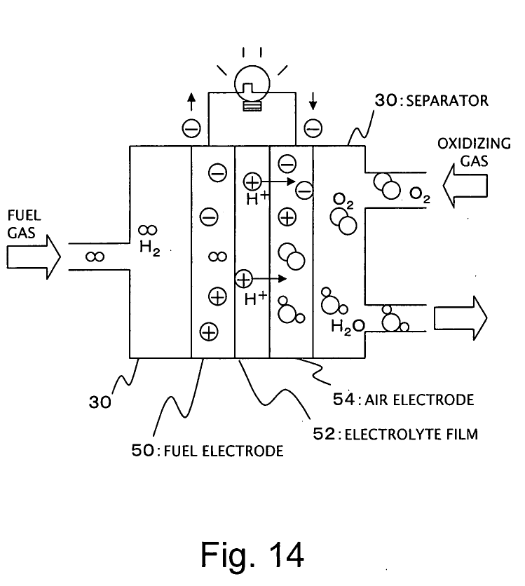

FIG. 15 is a flowchart describing one example of a conventional operation method for a fuel cell.

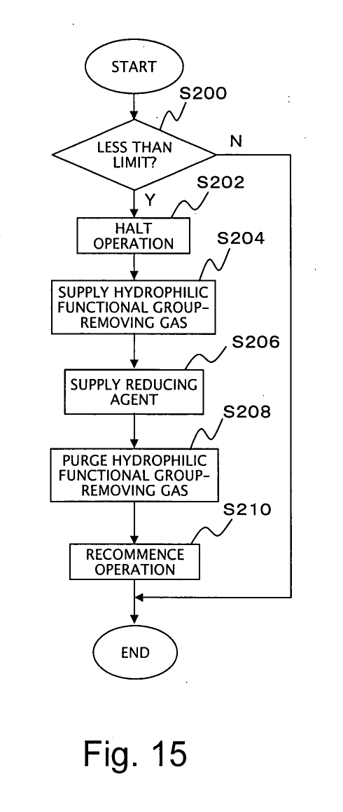

### BEST MODE FOR CARRYING OUT THE INVENTION

As follows is a description of embodiments of the present invention, based on the drawings.

The present invention provides a fuel cell system having a fuel cell containing cells that are composed of an assembly having a fuel electrode and an air electrode on an electrolyte film, and separators that are laminated to the assembly, wherein the fuel cell has a drainage additive supply unit that supplies a drainage additive for improving the drainage properties within the cell.

In the embodiments described below, a cell in which the assembly is sandwiched between a pair of separators is taken as an example, but the present invention is not limited to this configuration, and for example also includes stacked fuel cells in which the separators are laminated to the assemblies with two cells having a single separator in common.

Using a drainage maintenance agent as the aforementioned drainage additive, a fuel cell system in which the drainage properties are improved by reducing the surface tension of the reaction water generated within the cells is described below with reference to a first embodiment and a second embodiment.

### FIRST EMBODIMENT

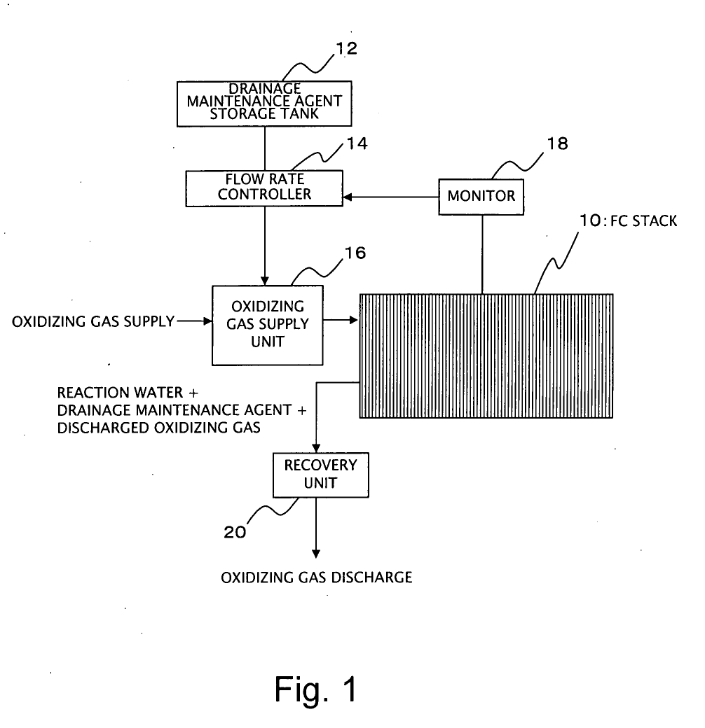

As shown in FIG. 1, the fuel cell system according to this embodiment comprises a fuel cell stack (hereafter referred to as the “FC stack”) 10, in which an assembly (MEA: Membrane Electrode Assembly) comprising an electrolyte film formed from a solid polymer film sandwiched between two electrodes, namely a fuel electrode and an air electrode, is itself sandwiched between two separators to generate a cell that functions as the smallest unit, and a plurality of these cells are then normally stacked together, a drainage maintenance agent storage tank 12 that stores a drainage maintenance agent, a flow rate controller 14 that controls the flow rate of the drainage maintenance agent supplied from the drainage maintenance agent storage tank 12, an oxidizing gas supply unit 16 that mixes the drainage maintenance agent supplied from the flow rate controller 14 with an oxidizing gas, and then supplies the resulting mixture to an oxidizing gas supply passage of the FC stack 10, a monitor 18 that monitors the usage state of the FC stack 10, and a recovery unit 20 that recovers the drainage maintenance agent from the mixture of reaction water, drainage maintenance agent and discharged oxidizing gas that is discharged from the FC stack 10.

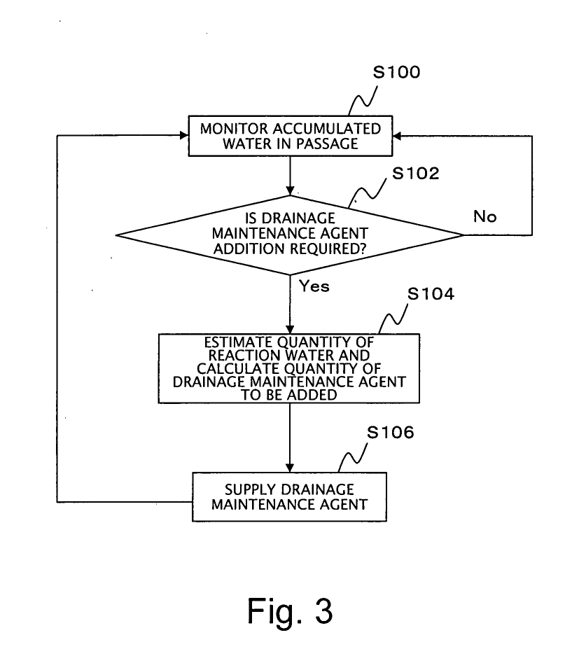

Next is a description of the operation of the fuel cell system of this embodiment, with reference to FIG. 1 and FIG. 3.

The usage state of the FC stack 10 is monitored by the monitor 18 (S100), and when a judgment is made that discharge of reaction water within the gas passages is lagging, causing an accumulation of water that requires the addition of a drainage maintenance agent (S102), the monitor 18 estimates the quantity of reaction water and calculates the quantity of drainage maintenance agent to be added in accordance with the quantity of discharged reaction water, and then instructs the flow rate controller 14 to supply the required quantity of the drainage maintenance agent from the drainage maintenance agent storage tank 12 (S104). Upon receipt of this instruction from the monitor 18, the flow rate controller 14 supplies the required quantity of the drainage maintenance agent from the drainage maintenance agent storage tank 12 to the oxidizing gas supply unit 16 (S106). This supply of the drainage maintenance agent by the flow rate controller 14 may be conducted either intermittently or continuously, although by conducting the supply intermittently, the quantity consumed of the drainage maintenance agent can be reduced compared with the case of continuous supply. Subsequently, at the oxidizing gas supply unit 16, the drainage maintenance agent is mixed with the oxidizing gas, and the resulting mixture is supplied to the oxidizing gas supply passage of the FC stack 10. As a result, as the oxidizing gas diffuses, the drainage maintenance agent is supplied right through to the oxidizing gas discharge passage, the excess reaction water at the air electrode (the cathode side) can be discharged from the fuel cell system, and the output properties of the fuel cell can be maintained and stabilized. Moreover, the reaction water, drainage maintenance agent and discharged oxidizing gas that are discharged from the oxidizing gas discharge passage of the FC stack 10 are separated into the drainage maintenance agent and a mixture of reaction water and discharged oxidizing gas by the recovery unit 20 provided within the oxidizing gas discharge passage, and the drainage maintenance agent is then recovered and, for example, returned to the drainage maintenance agent storage tank 12.

### SECOND EMBODIMENT

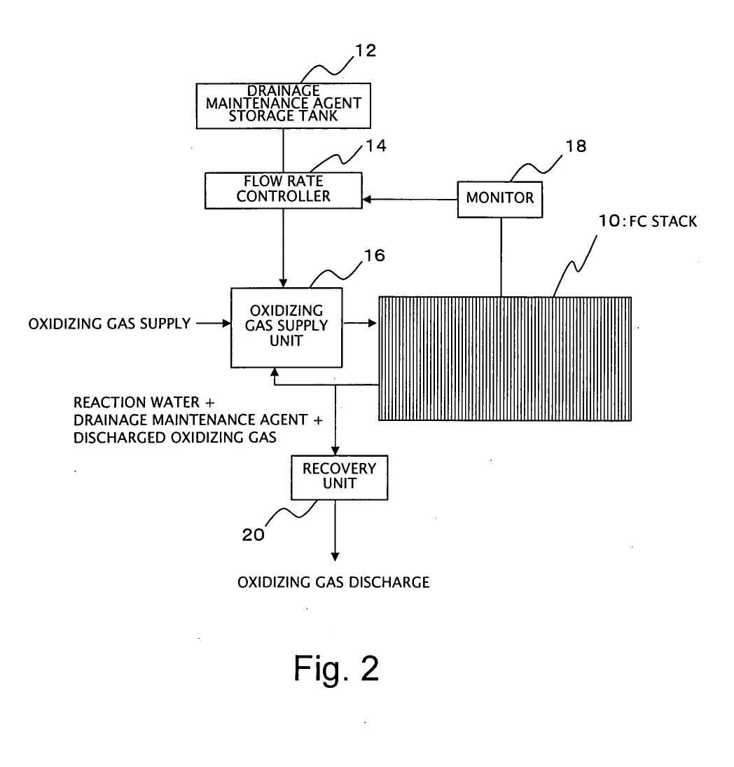

With the exception of returning to the oxidizing gas supply unit 16 either a portion of, or all of, the reaction water, drainage maintenance agent and discharged oxidizing gas that are discharged from the FC stack 10, the alternative fuel cell system of the second embodiment shown in FIG. 2 has the same structure as the fuel cell system shown above in FIG. 1.

Next is a description of the operation of the fuel cell system of this embodiment, with reference to FIG. 2 and FIG. 3.

The usage state of the FC stack 10 is monitored by the monitor 18 (S100), and in particular, the humidity of the exhaust gas discharged from the cells within the fuel cell is measured, and when a judgment is made that discharge of reaction water within the gas passages is lagging, causing an accumulation of water that requires the addition of a drainage maintenance agent (S102), the monitor 18 estimates the quantity of reaction water and calculates the quantity of drainage maintenance agent to be added in accordance with the quantity of discharged reaction water, and then instructs the flow rate controller 14 to supply the required quantity of the drainage maintenance agent from the drainage maintenance agent storage tank 12 (S104). Upon receiving instruction from the monitor 18, the flow rate controller 14 supplies the required quantity of the drainage maintenance agent from the drainage maintenance agent storage tank 12 to the oxidizing gas supply unit 16 (S106). This supply of the drainage maintenance agent by the flow rate controller 14 may be conducted either intermittently or continuously, although by conducting the supply intermittently, the quantity consumed of the drainage maintenance agent can be reduced compared with the case of continuous supply. Subsequently, at the oxidizing gas supply unit 16, the drainage maintenance agent is mixed with the oxidizing gas, and the resulting mixture is supplied to the oxidizing gas supply passage of the FC stack 10. As a result, as the oxidizing gas diffuses, the drainage maintenance agent is supplied right through to the oxidizing gas discharge passage, the excess reaction water at the air electrode (the cathode side) can be discharged from the fuel cell system, and the output properties of the fuel cell can be maintained and stabilized. Moreover, either a portion of, or all of, the reaction water, drainage maintenance agent and discharged oxidizing gas discharged from the oxidizing gas discharge passage of the FC stack 10 is returned to the oxidizing gas supply unit 16 and then re-supplied to the FC stack 10. On the other hand, when the quantity of the drainage maintenance agent supplied to the FC stack 10 becomes excessive, the recovery unit 20 provided within the oxidizing gas discharge passage conducts a separation into the drainage maintenance agent and a mixture of reaction water and discharged oxidizing gas, and the drainage maintenance agent is then recovered and, for example, returned to the drainage maintenance agent storage tank 12.

As follows is a more detailed description of the fuel cell systems according to the first embodiment and the second embodiment.

The drainage maintenance agent (hydrophilicity maintenance agent) described above improves the hydrophilicity of the gas passages within the cells, and preferably maintains the hydrophilicity of the surfaces of the gas passages formed in the separators 30. Moreover, the drainage maintenance agent (hydrophilicity maintenance agent) is preferably a surface tension reduction agent that reduces the surface tension of the reaction water generated within the cells, and this surface tension reduction agent is preferably at least one reagent selected from the group consisting of alcohols and surfactants. Furthermore, alcohols of not more than 6 carbon atoms are preferred as the alcohol, and ethanol is particularly desirable. Furthermore, the surfactant may employ any one of a nonionic surfactant, anionic surfactant, cationic surfactant or amphoteric surfactant, although surfactants that do not contain metal ions, nitrogen atoms or phosphorus atoms are preferred, nonionic surfactants are even more preferred, and nonionic surfactants having short chain lengths are particularly desirable. The washing liquid that is loaded within a vehicle may be used as the drainage maintenance agent. In such a case, there is no need to provide a separate drainage maintenance agent storage tank 12, enabling the fuel cell system to be more compact.

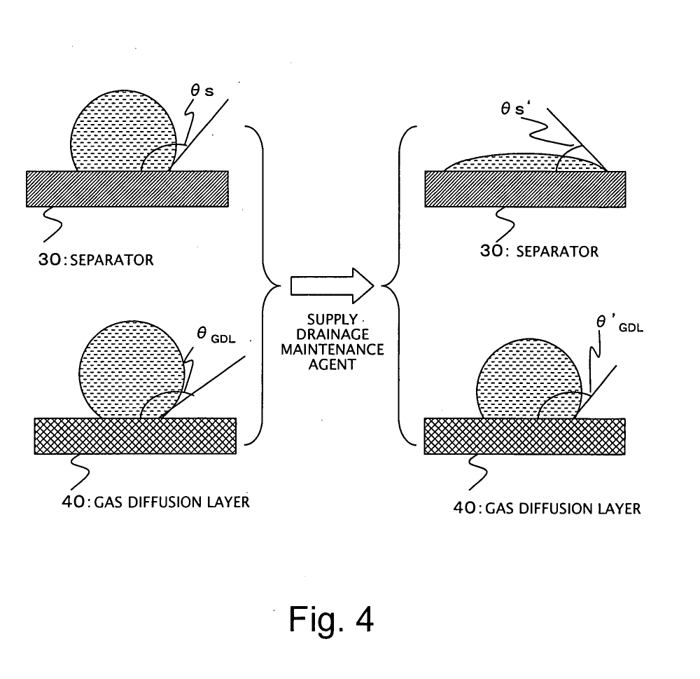

As shown in FIG. 4, the drainage maintenance agent is preferably a reagent that reduces the surface tension of reaction water at the surface of the separator 30 from θ_{S} to θ_{S}′, wherein the value of θ_{S}′ is preferably not more than 90 degrees, and moreover, even if the surface tension of reaction water at the surface of the gas diffusion layer 40 of the electrodes within the cells falls from θ_{GDL} to θ_{GDL}′, the value of θ_{GDL}′ is still at least 90 degrees. By ensuring θ_{S}′ and θ_{GDL}′ values within the above ranges, the reaction water that has adsorbed to the separator and is inhibiting gas diffusion can be discharged efficiently from the fuel cell, while a satisfactory level of water repellency is maintained at the gas diffusion layer of the electrode. Furthermore, the drainage maintenance agent is preferably a reagent that is unlikely to penetrate into the electrode diffusion layer.

Furthermore, the monitor 18 measures the usage state of the fuel cell, such as the length of time the fuel cell has been used (operated), the power generation state of the fuel cell, the cell temperature within the fuel cell, or makes a judgment as to whether or not the power generation properties of the fuel cell indicate occurrence of the flatting phenomenon.

In a more detailed description, in those cases where the “length of time the fuel cell has been used (operated)” is employed, the monitor 18 includes a clock function, and when a pre-measured “usage (operation) time limit” is reached, which is set to indicate that the electrode diffusion layers within the fuel cell have become excessively wet, the monitor instructs the flow rate controller 14 to supply a quantity of the drainage maintenance agent that is sufficient to deal with the quantity of reaction water estimated to have been generated by the time the electrode diffusion layers reach the excessively wet state.

Furthermore, in those cases where the “power generation state of the fuel cell” is employed, the monitor 18 includes an ammeter function that measures the electrical current output of the fuel cell, and because the quantity of reaction water can be estimated on the basis of the electrical current value, when the quantity of reaction water is deemed to have reached an excessively wet state, the monitor instructs the flow rate controller 14 to supply a quantity of the drainage maintenance agent that is sufficient to deal with the quantity of reaction water.

Furthermore, in those cases where the “cell temperature within the fuel cell” is employed, the monitor 18 includes a temperature measurement function, and when the normal cell operating temperature, for example 80° C., falls below a threshold cell temperature, for example 30° C., the monitor instructs the flow rate controller 14 to supply a quantity of the drainage maintenance agent which, based on a correlation between cell temperature and the quantity of reaction water that has been measured in advance, is sufficient to deal with the quantity of reaction water estimated to have been generated by the time the temperature falls below the threshold cell temperature.

Furthermore, in those cases where a “judgment as to whether or not the power generation properties of the fuel cell indicate occurrence of the flatting phenomenon” is employed, the monitor 18 includes a voltage measurement function, a measurement is made in advance to determine the voltage value at the point where the flatting phenomenon occurs within the fuel cell and this measured voltage value is set as a threshold voltage, and when this threshold voltage is reached, the monitor instructs the flow rate controller 14 to supply a quantity of the drainage maintenance agent that is sufficient to deal with the quantity of reaction water estimated to have been generated by the flatting phenomenon.

In this embodiment, the monitor 18 preferably has an electrical current measurement function, a cell temperature measurement function, and a function that is capable of measuring the quantity of reaction gas supplied, and by using the electrical current value and the reaction gas flow rate, the quantity of reaction water generated can be more accurately estimated, where as the cell temperature can be used to calculate the quantity of reaction water accumulated within the cell. Accordingly, a quantity of the drainage maintenance agent that more precisely matches the quantity of accumulated reaction water can be supplied.

The monitor 18 is not restricted to this configuration, and other possible configurations include monitors that are able to estimate the quantity of reaction water within the cells based on the internal cell environment, such as the cell temperature, the external temperature, the cell load, the stoichiometric ratio and the operational history, monitors that contain mapping information that maps the aforementioned internal cell environment, and are able to estimate the quantity of reaction water based on this mapping information, and monitors that measure the pressure loss accompanying water accumulation within the FC stack, and then estimate the quantity of reaction water based on this pressure loss.

Furthermore, the drainage maintenance agent is preferably added in a quantity within a range from 0 to 15% by weight relative to the quantity of reaction water that needs to be discharged. Normally, if a quantity of the drainage maintenance agent is added that exceeds 50% by weight relative to the quantity of reaction water that needs to be discharged, then although the wetting properties of the separators improve and the discharge of the reaction water improves, the contact angle of water relative to the electrode diffusion layer decreases, which is undesirable as it causes the water repellency of the diffusion layer to deteriorate, increases the possibility of a reduction in the fuel cell output, and increases the possibility of the drainage maintenance agent penetrating into the electrode diffusion layer.

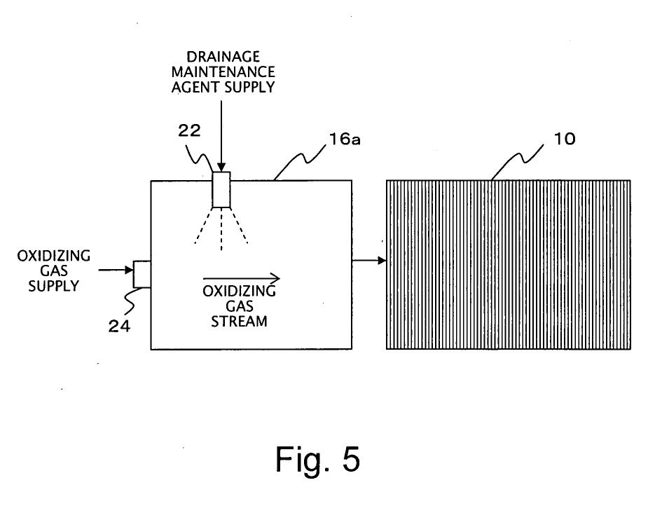

The oxidizing gas supply unit of the aforementioned first and second embodiments is described in detail below with reference to FIG. 5 through FIG. 7.

FIG. 5 shows one example of an injection-type oxidizing gas supply unit 16a that functions as the oxidizing gas supply unit. As shown in FIG. 5, the oxidizing gas supply unit 16a is provided with an injection nozzle 22 that sprays the drainage maintenance agent supplied from the flow rate controller in the form a fine mist, and an oxidizing gas inlet 24 that introduces the oxidizing gas into the interior of the oxidizing gas supply unit 16a in a direction perpendicular to the spray direction of the drainage maintenance agent. Accordingly, the required quantity of the drainage maintenance agent is sprayed from the injection nozzle 22 and diffuses in the form of a fine mist, and because the oxidizing gas is introduced into this region of diffused mist, the mist-like drainage maintenance agent is carried by the oxidizing gas stream and supplied to the FC stack 10 in a uniformly dispersed state. As a result, the mist-like drainage maintenance agent dissolves in the reaction water, thereby reducing the contact angle of the reaction water relative to the separators, and improving the discharge of the reaction water.

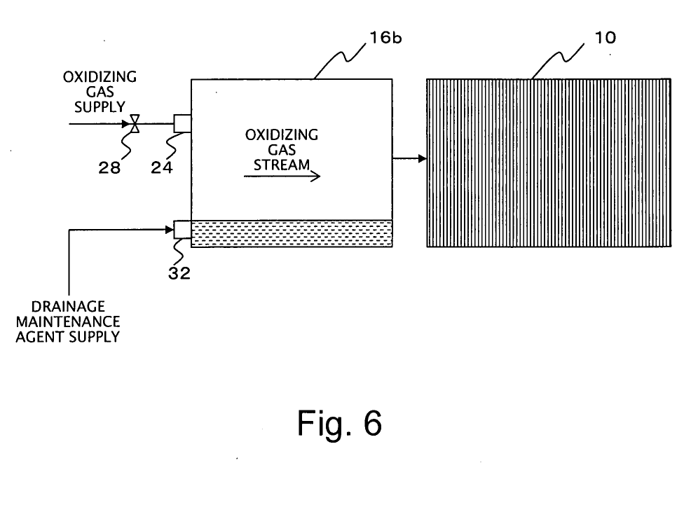

FIG. 6 shows one example of a carburetor-type oxidizing gas supply unit 16b that functions as the oxidizing gas supply unit. As shown in FIG. 6, the oxidizing gas supply unit 16b is provided with a drainage maintenance agent inlet 32 that introduces the drainage maintenance agent supplied from the flow rate controller into the interior of the oxidizing gas supply unit 16b, and a pressure regulating valve 28 that regulates the pressure of the oxidizing gas and introduces the oxidizing gas into the interior of the oxidizing gas supply unit 16b via an oxidizing gas inlet 24. Accordingly, by using the pressure regulating valve 28 to regulate the pressure of the oxidizing gas introduced into the interior of the oxidizing gas supply unit 16b, the required quantity of the drainage maintenance agent is sucked up from the surface of the drainage maintenance agent liquid inside the oxidizing gas supply unit 16b as a result of the negative pressure associated with the travel speed of the oxidizing gas, enabling the oxidizing gas with the drainage maintenance agent dispersed uniformly therein to be supplied to the FC stack 10. As a result, the drainage maintenance agent that is dispersed uniformly within the oxidizing gas dissolves in the reaction water, thereby reducing the contact angle of the reaction water relative to the separators, and as a result, improving the discharge of the reaction water.

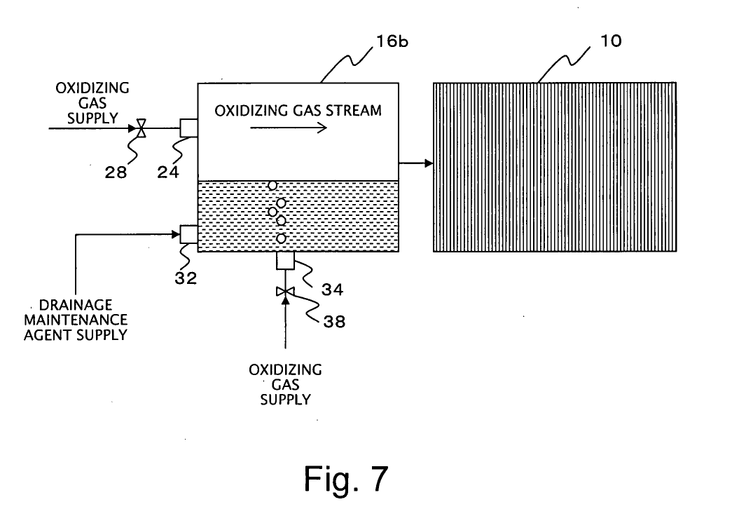

FIG. 7 shows one example of a bubbling-type oxidizing gas supply unit 16c that functions as the oxidizing gas supply unit. As shown in FIG. 7, the oxidizing gas supply unit 16c is provided with a drainage maintenance agent inlet 32 that introduces the drainage maintenance agent supplied from the flow rate controller into the interior of the oxidizing gas supply unit 16c, a pressure regulating valve 28 that regulates the pressure of oxidizing gas and introduces a portion of the oxidizing gas into the interior of the oxidizing gas supply unit 16c via an oxidizing gas inlet 24, and a pressure regulating valve 38 that regulates the pressure of oxidizing gas and introduces a portion of the oxidizing gas into the interior of the oxidizing gas supply unit 16c via an oxidizing gas inlet 34. Moreover, the oxidizing gas inlet 34 is provided in the bottom surface of the oxidizing gas supply unit 16c. Accordingly, the oxidizing gas that is introduced through the oxidizing gas inlet 34, having undergone pressure regulation by the pressure regulating valve 38, passes through the oxidizing gas inlet 34 and is introduced into a liquid comprising the drainage maintenance agent, a certain quantity of which is stored within the oxidizing gas supply unit 16c, and as the bubbles of this oxidizing gas rise to the surface of the liquid and burst, the resulting mist-like drainage maintenance agent is carried by the oxidizing gas stream introduced into the oxidizing gas supply unit 16b from the pressure regulating valve 28, and is supplied to the FC stack 10 in a uniformly dispersed state together with the oxidizing gas. As a result, the drainage maintenance agent that is dispersed uniformly within the oxidizing gas dissolves in the reaction water, thereby reducing the contact angle of the reaction water relative to the separators, and as a result, improving the discharge of the reaction water.

Next is a description of the recovery unit 20 within the fuel cell systems of the first and second embodiments, with reference to FIG. 1.

The recovery unit 20 comprises a heating unit within a pressure-resistant container, and if required also comprises a pressure reduction unit. When a mixture of reaction water, the drainage maintenance agent and discharged oxidizing gas is introduced into the recovery unit 20 from the FC stack 10, the mixture is stored for a predetermined period at a temperature of 25° C., is separated into a liquid phase and a gas phase, and the oxidizing gas contained within the gas phase is discharged. Subsequently, the residual liquid phase inside the recovery unit 20 is heated by the heating unit to a temperature that vaporizes the drainage maintenance agent, so that for example, in those cases where an ethanol is used as the drainage maintenance agent, the temperature is raised to at least 64° C. but no more than 100° C. in the case of methanol, or to at least 78° C. but no more than 100° C. in the case of ethanol, thereby distilling off the drainage maintenance agent and enabling separation and recovery from the water. If a pressure reduction unit is used, then the heating temperature of the heating unit can be lowered. In those cases where a surfactant or a washing liquid is used as the drainage maintenance agent, separation from the water is more difficult than in the case of the ethanol described above, and consequently a method such as that shown in FIG. 2, wherein the mixture of reaction water, the drainage maintenance agent and discharged oxidizing gas that is discharged from the FC stack 10 is returned to the oxidizing gas supply unit 16 and recycled, is more efficient.

Furthermore, because ethanol and washing liquids have extremely low toxicity, in those cases where ethanol or a washing liquid is used as the drainage maintenance agent, in some cases it may also be permissible to externally discharge the drainage maintenance agent from the fuel cell system rather than recovering it via the recovery unit 20.

The above description focuses mainly on the introduction of a drainage maintenance agent to the cathode side where reaction water is generated, but the present invention is not limited to this configuration, and a configuration in which a fuel gas supply unit introduces a drainage maintenance agent to the anode side in the same manner as that shown in FIGS. 1 and 2 is also possible.

Using a water repellent agent as the aforementioned drainage additive, a fuel cell system in which the drainage of reaction water from within the cells is improved by imparting the surface of the reaction gas supply passages within the cells with water repellency is described below using a third embodiment and a fourth embodiment.

### THIRD EMBODIMENT

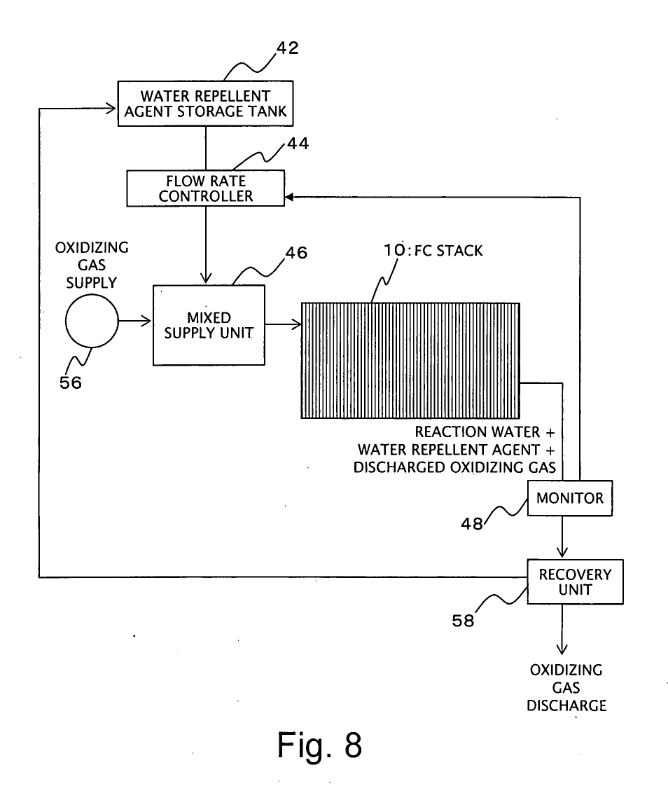

The fuel cell system according to this preferred embodiment of the present invention comprises, for example, a fuel cell stack (hereafter referred to as the “FC stack”) 10, in which an assembly (MEA: Membrane Electrode Assembly) comprising an electrolyte film formed from a solid polymer film sandwiched between two electrodes, namely a fuel electrode and an air electrode, is itself sandwiched between two separators to generate a cell that functions as the smallest unit, and a plurality of these cells are then stacked together as shown in FIG. 8, a water repellent agent storage tank 42 that stores a water repellent agent, a flow rate controller 44 that controls the flow rate of the water repellent agent supplied from the water repellent agent storage tank 42, a mixed supply unit 46 that mixes the water repellent agent supplied from the flow rate controller 44 with an oxidizing gas, and then supplies the resulting mixture to an oxidizing gas supply passage of the FC stack 10, a cathode-side pump 56 that supplies the oxidizing gas to the mixed supply unit 46, a monitor 48 that detects the quantity of water repellent agent discharged from the FC stack 10, and a recovery unit 58 that functions as a trapping unit for trapping and recovering the water repellent agent from the mixture of reaction water, water repellent agent and discharged oxidizing gas that is discharged from the FC stack 10.

An analysis device that is capable of detecting the water repellent agent, such as a gas chromatography or liquid chromatography device, can be used as the monitor 48.

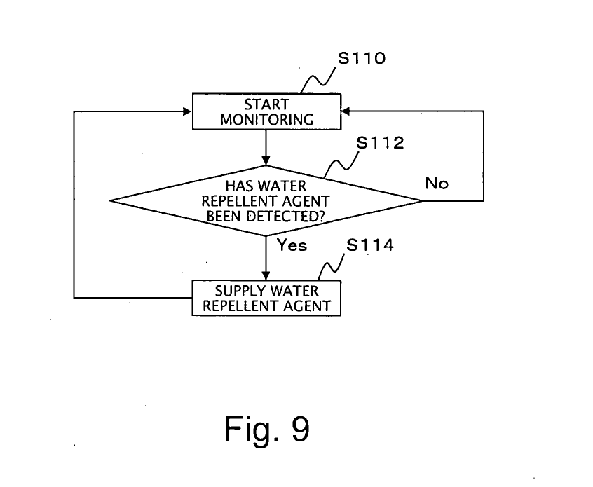

Next is a description of the operation of the fuel cell system of this embodiment, with reference to FIG. 8 and FIG. 9.

Monitoring is conducted using the monitor 48 (S110), and when the monitor 48 detects that the water repellent agent is being discharged from the FC stack 10 (S112), the monitor 48 instructs the flow rate controller 44 to supply a required quantity of the water repellent agent. Upon receipt of this instruction from the monitor 48, the flow rate controller 44 supplies the required quantity of the water repellent agent from the water repellent agent storage tank 42 to the mixed supply unit 46 (S114). This supply of the water repellent agent by the flow rate controller 44 may be conducted either intermittently or continuously, although by conducting the supply intermittently, the quantity consumed of the water repellent agent can be reduced compared with the case of continuous supply. Subsequently, the oxidizing gas is supplied to the mixed supply unit 46 from the cathode-side pump 56, and the water repellent agent and the oxidizing gas are then mixed together within the mixed supply unit 46 and supplied to the oxidizing gas supply passages within the FC stack 10. As a result, as the oxidizing gas diffuses, the water repellent agent is supplied right through to the oxidizing gas discharge passage, the excess reaction water at the air electrode (the cathode side) can be discharged from the fuel cell, excessive wetting of the diffusion layer and catalyst layer of the electrodes inside the fuel cell can be prevented, and the diffusion efficiency of the reaction gas can be maintained, meaning the output properties of the fuel cell can be stabilized. Moreover, the reaction water, water repellent agent and discharged oxidizing gas that are discharged from the oxidizing gas discharge passage of the FC stack 10 are separated into the water repellent agent and a mixture of reaction water and discharged oxidizing gas by the recovery unit 58 provided within the oxidizing gas discharge passage, and the water repellent agent is then recovered and, for example, returned to the water repellent agent storage tank 42.

In this embodiment, any device that is capable of detecting the water repellent agent can be used as the monitor 48, but the present invention is not limited to this configuration, and for example, the monitor 48 may also measure the usage state of the fuel cell, such as the length of time the fuel cell has been used (operated), the power generation state of the fuel cell, the cell temperature within the fuel cell, or make a judgment as to whether or not the power generation properties of the fuel cell indicate occurrence of the flatting phenomenon.

In a more detailed description, in those cases where the “length of time the fuel cell has been used (operated)” is employed, the monitor 48 includes a clock function, and when a pre-measured “usage (operation) time limit” is reached, which is set to indicate that the electrode diffusion layers within the fuel cell have become excessively wet, the monitor instructs the flow rate controller 44 to supply a quantity of the water repellent agent that is sufficient to deal with the quantity of reaction water estimated to have been generated by the time the electrode diffusion layers reach the excessively wet state.

Furthermore, in those cases where the “power generation state of the fuel cell” is employed, the monitor 48 includes an ammeter function that measures the electrical current output of the fuel cell, and because the quantity of reaction water can be estimated on the basis of the electrical current value, when the quantity of reaction water is deemed to have reached an excessively wet state, the monitor instructs the flow rate controller 44 to supply a quantity of the water repellent agent that is sufficient to deal with the quantity of reaction water.

Furthermore, in those cases where the “cell temperature within the fuel cell” is employed, the monitor 48 includes a temperature measurement function, and when the normal cell operating temperature, for example 80° C., falls below a threshold cell temperature, for example 30° C., the monitor instructs the flow rate controller 44 to supply a quantity of the water repellent agent which, based on a correlation between cell temperature and the quantity of reaction water that has been measured in advance, is sufficient to deal with the quantity of reaction water estimated to have been generated by the time the temperature falls below the threshold cell temperature.

Furthermore, in those cases where a “judgment as to whether or not the power generation properties of the fuel cell indicate occurrence of the flatting phenomenon” is employed, the monitor 48 includes a voltage measurement function, a measurement is made in advance to determine the voltage value at the point where the flatting phenomenon occurs within the fuel cell and this measured voltage value is set as a threshold voltage, and when this threshold voltage is reached, the monitor instructs the flow rate controller 44 to supply a quantity of the water repellent agent that is sufficient to deal with the quantity of reaction water estimated to have been generated by the flatting phenomenon.

In this embodiment, the monitor 48 preferably has an electrical current measurement function, a cell temperature measurement function, and a function that is capable of measuring the quantity of reaction gas supplied, and by using the electrical current value and the reaction gas flow rate, the quantity of reaction water generated can be more accurately estimated, where as the cell temperature can be used to calculate the quantity of reaction water accumulated within the cell. Accordingly, a quantity of the water repellent agent that more precisely matches the quantity of accumulated reaction water can be supplied.

The monitor 48 may also include monitors that are able to estimate the quantity of reaction water within the cells based on the internal cell environment, such as the cell temperature, the external temperature, the cell load, the stoichiometric ratio and the operational history, monitors that contain mapping information that maps the aforementioned internal cell environment, and are able to estimate the quantity of reaction water based on this mapping information, and monitors that measure the pressure loss accompanying water accumulation within the FC stack, and then estimate the quantity of reaction water based on this pressure loss.

In those cases where, in the manner described above, a monitor that monitors the usage state of the fuel cell is used, the monitor 48 may be used to monitor the usage state within the fuel cell, and when the output properties of the fuel cell are deemed to have decreased, the monitor then estimates the quantity of reaction water, calculates the quantity of water repellent agent that should be added to deal with the discharged quantity of reaction water, and then instructs the flow rate controller 44 to supply the required quantity of water repellent agent from the water repellent agent storage tank 42.

### FOURTH EMBODIMENT

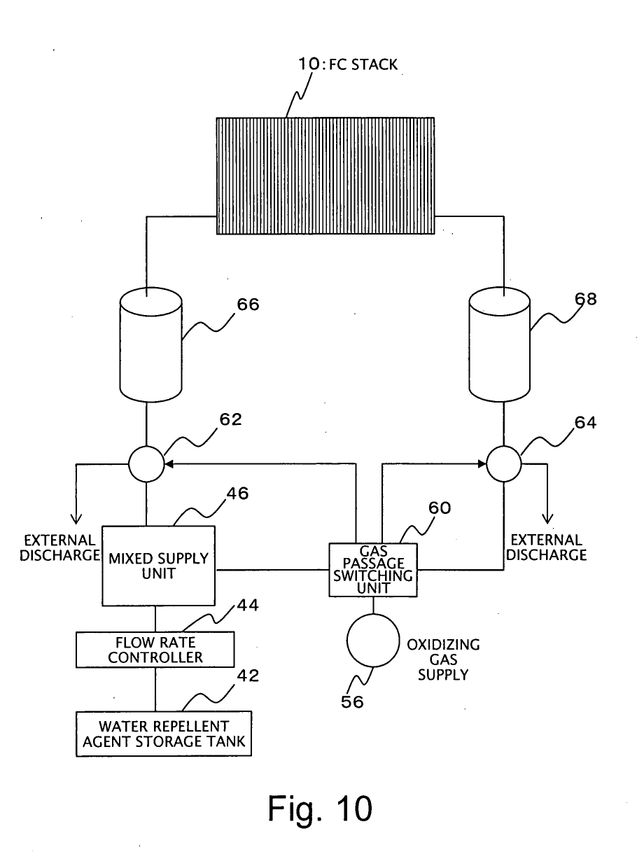

Furthermore, FIG. 10 shows an example of another fuel cell system according to a fourth embodiment. Those structures that that are the same as those of the fuel cell system described using FIG. 8 and FIG. 9 are assigned the same symbols, and their description is omitted here.

The alternative fuel cell system of this embodiment shown in FIG. 10 comprises, for example, a fuel cell stack (hereafter referred to as the “FC stack”) 10, in which an assembly (MEA: Membrane Electrode Assembly) comprising an electrolyte film formed from a solid polymer film sandwiched between two electrodes, namely a fuel electrode and an air electrode, is itself sandwiched between two separators to generate a cell that functions as the smallest unit, and a plurality of these cells are then stacked together as shown in FIG. 10, a water repellent agent storage tank 42 that stores a water repellent agent, a flow rate controller 44 that controls the flow rate of the water repellent agent supplied from the water repellent agent storage tank 42, a mixed supply unit 46 that mixes the water repellent agent supplied from the flow rate controller 44 with an oxidizing gas, and then supplies the resulting mixture to an oxidizing gas supply passage of the FC stack 10, a cathode-side pump 56 that supplies the oxidizing gas to the mixed supply unit 46, as well as a gas passage switching unit 60 that switches the passage for the oxidizing gas supplied from the cathode-side pump 56, three way coupling valves 62, 64 that open and close in accordance with instructions from the gas passage switching unit 60, and are able to externally discharge the oxidizing gas and reaction water discharged from the FC stack 10 when the passage is set to the discharge side, and trappers 66, 68 that function as first and second trapping units for trapping the water repellent agent discharged from the FC stack 10.

In the above embodiment, the gas passage switching unit 60 not only switches the reaction gas passage, but also measures, in advance, the quantity of the water repellent agent that is able to be trapped by the trappers 66, 68, and the relationship between the reaction gas supply time and the quantity of the water repellent agent that is discharged from the FC stack 10 together with the discharged oxidizing gas, and based on these two results, calculates the reaction gas supply time that corresponds with the maximum quantity of water repellent agent able to be trapped by the trappers 66, 68, and then stores this time as a prescribed time Tr. Moreover, the gas passage switching unit 60 also has a clock function, and counts the reaction gas supply time T.

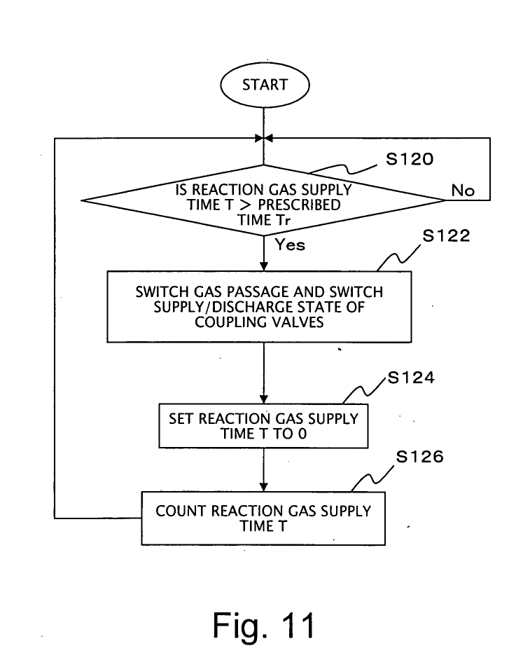

Next is a description of the operation of this alternative fuel cell system of the fourth embodiment, with reference to FIG. 10 and FIG. 11.

First, the gas passage switching unit 60 outputs an instruction to the coupling valve 62 to “open” the connection between the mixed supply unit 46 and the trapper 66 and “close” the external discharge, and outputs an instruction to the coupling valve 64 to “close” the connection between the gas passage switching unit 60 and the trapper 68 and “open” the external discharge. Subsequently, the gas passage switching unit 60 uses its built-in clock function to count the reaction gas supply time T, starting from 0. At the same time, the oxidizing gas is supplied from the cathode-side pump 56 to the mixed supply unit 46 via the gas passage switching unit 60, where as the flow rate controller 44 supplies a required quantity of the water repellent agent from the water repellent agent storage tank 42 to the mixed supply unit 46. The water repellent agent and the oxidizing gas, which are mixed together within the mixed supply unit 46, then pass through the coupling valve 62 and the trapper 66, and are supplied to the FC stack 10. The water repellent agent, which is supplied with the oxidizing gas to the oxidizing gas passages of each cell within the fuel cell, adsorbs to the diffusion layer and the catalyst layer of the air electrode. The mixture of discharged oxidizing gas, reaction water and a portion of the water repellent agent that is discharged from the FC stack 10 is transported to the trapper 68, the trapper 68 traps only the water repellent agent, and the reaction water and discharged oxidizing gas are discharged externally via the coupling valve 64.

Subsequently, the gas passage switching unit 60 determines whether or not the reaction gas supply time T has exceeded the aforementioned prescribed time Tr (S120). If the gas passage switching unit 60 determines that the reaction gas supply time T exceeds the prescribed time Tr, then the gas passage switching unit 60 outputs an instruction to the coupling valve 62 to “close” the connection between the mixed supply unit 46 and the trapper 66 and “open” the external discharge, and outputs an instruction to the coupling valve 64 to “open” the connection between the gas passage switching unit 60 and the trapper 68 and “close” the external discharge (S122). Subsequently, the gas passage switching unit 60 uses its built-in clock function to reset the reaction gas supply time T to “0” (S124), and restarts the counting process (S126). At the same time, the oxidizing gas is supplied from the cathode-side pump 56 to the trapper 68 via the gas passage switching unit 60 and the coupling valve 64. The water repellent agent adsorbed within the trapper 68 is pulled away by the flow rate of the supplied oxidizing gas, and is supplied to the FC stack 10 together with the oxidizing gas. The water repellent agent, which is supplied with the oxidizing gas to the oxidizing gas passages of each cell within the fuel cell, adsorbs to the diffusion layer and the catalyst layer of the air electrode. The mixture of discharged oxidizing gas, reaction water and a portion of the water repellent agent that is discharged from the FC stack 10 is transported to the trapper 66, the trapper 66 traps only the water repellent agent, and the reaction water and discharged oxidizing gas are discharged externally via the coupling valve 62.

In a similar manner, the gas passage switching unit 60 then determines whether or not the reaction gas supply time T has exceeded the aforementioned prescribed time Tr (S120). If the gas passage switching unit 60 determines that the reaction gas supply time T exceeds the prescribed time Tr, then the gas passage switching unit 60 outputs an instruction to the coupling valve 62 to “open” the connection between the mixed supply unit 46 and the trapper 66 and “close” the external discharge, and outputs an instruction to the coupling valve 64 to “close” the connection between the gas passage switching unit 60 and the trapper 68 and “open” the external discharge (S122). Subsequently, the gas passage switching unit 60 uses its built-in clock function to reset the reaction gas supply time T to “0” (S124), and restarts the counting process (S126). At this point, no new water repellent agent is supplied from the flow rate controller 44 to the mixed supply unit 46. At the same time, the oxidizing gas is supplied from the cathode-side pump 56 to the trapper 66 via the gas passage switching unit 60 and the coupling valve 62. The water repellent agent adsorbed within the trapper 66 is pulled away by the flow rate of the supplied oxidizing gas, and is supplied to the FC stack 10 together with the oxidizing gas. The water repellent agent, which is supplied with the oxidizing gas to the oxidizing gas passages of each cell within the fuel cell, adsorbs to the diffusion layer and the catalyst layer of the air electrode. The mixture of discharged oxidizing gas, reaction water and a portion of the water repellent agent that is discharged from the FC stack 10 is transported to the trapper 68, the trapper 68 traps only the water repellent agent, and the reaction water and discharged oxidizing gas are discharged externally via the coupling valve 64.

By switching the gas passage in the manner described above, replenishment of the water repellent agent can be suppressed to a minimum.

In those cases where the output properties of the fuel cell start to deteriorate as a result of reusing the water repellent agent within the fuel cell system, a monitor not shown in the drawings is preferably used to monitor the usage state of the fuel cell, and supply a suitable quantity of freshwater repellent agent from the water repellent agent storage tank 42 to the mixed supply unit 46 via the flow rate controller 44.

Furthermore, a more detailed description of the fuel cell systems of the third and fourth embodiments is provided below.

The water repellent agent described above may be any substance that is able to maintain the hydrophobicity of the electrode diffusion layer and catalyst layer relative to the reaction water generated within the cell, exhibits a high degree of adsorption to the diffusion layer and the catalyst layer, exhibits no possibility of reaction with the reaction gas (and particularly the oxidizing gas), and is able to exist in a liquid or solid state at the operating temperature of the fuel cell, for example at a temperature within a range from 70 to 80° C., and at least one material selected from the group consisting of saturated fatty acids, unsaturated fatty acids, silicon resin powders, paraffins, waxes, fluororesin powders, and creosote oils is preferred, of these, saturated fatty acids, unsaturated fatty acids and silicon resin powders, which are substantially harmless to humans, are even more preferred, and unsaturated fatty acids of C17 or higher such as oleic acid, elaidic acid, linoleic acid, linolenic acid, stearic acid and arachidonic acid are particularly desirable.

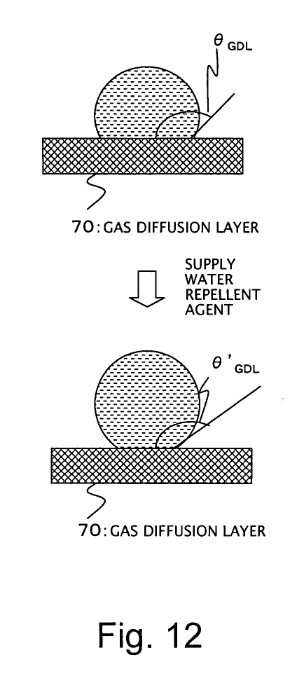

In particular, as shown in FIG. 12, the water repellent agent preferably increases the surface tension of reaction water at the surface of the gas diffusion layer 70 of the electrodes within the cells from θ_{GDL} to θ′_{GDL}, and the value of θ′_{GDL} is preferably at least 90 degrees. By ensuring a θ′_{GDL} value within this range, excessive wetting can be prevented and the reaction water that has adsorbed to the gas diffusion layer 70 and is inhibiting gas diffusion can be discharged efficiently from the fuel cell, while a satisfactory level of wetting is still maintained at the electrode gas diffusion layer.

Furthermore, the water repellent agent is typically added in a quantity within a range from 0 to 0.01% by weight, and preferably from 0.0001 to 0.005% by weight, relative to the quantity of reaction water that needs to be discharged. Even if a quantity of the water repellent agent that exceeds the above range is supplied, further increases in the water repellency are not desirable.

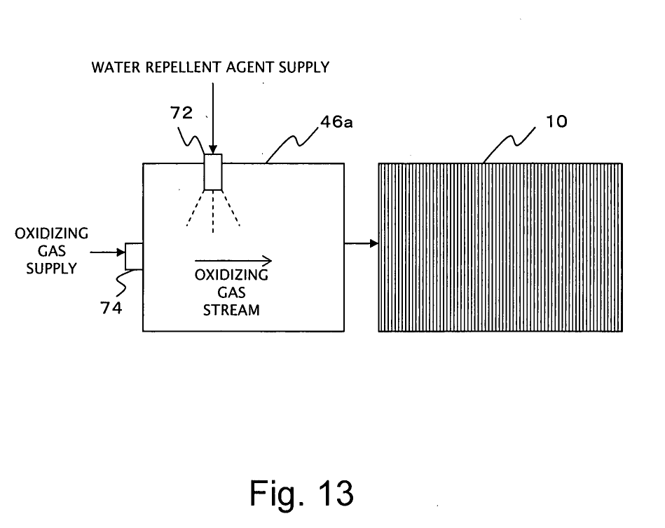

A detailed description of the mixed supply unit within the third and fourth embodiments described above is presented below with reference to FIG. 13.

FIG. 13 shows one example of an injection-type mixed supply unit 46a that functions as the mixed supply unit. As shown in FIG. 13, the mixed supply unit 46a is provided with an injection nozzle 72 that sprays the water repellent agent supplied from the flow rate controller in the form a fine mist, and an oxidizing gas inlet 74 that introduces the oxidizing gas into the interior of the mixed supply unit 46a in a direction perpendicular to the spray direction of the water repellent agent. Accordingly, the required quantity of the water repellent agent is sprayed from the injection nozzle 72 and diffuses in the form of a fine mist, and because the oxidizing gas is introduced into this region of diffused mist, the mist-like water repellent agent is carried by the oxidizing gas stream and supplied to the FC stack 10 in a uniformly dispersed state. As a result, the mist-like water repellent agent dissolves in the reaction water, thereby reducing the contact angle of the reaction water relative to the separators, and improving the discharge of the reaction water.

The mixed supply unit 46a may also include a heating unit, and in those case where the selected water repellent agent is a solid at room temperature (25° C.), the water repellent agent is preferably heated to a temperature sufficient to convert the agent to a liquid prior to supply to the injection nozzle 72, and the resulting liquid water repellent agent is then sprayed from the injection nozzle 72. In contrast, in those cases where the water repellent agent is a liquid at room temperature, although there is no compelling need to conduct heating using the heating unit, if the viscosity of the liquid water repellent agent is overly high, making spraying difficult, then the heating unit is preferably used to lower the viscosity of the water repellent, agent.

Furthermore, the recovery unit 58 shown in FIG. 8 and the trappers 66, 68 shown in FIG. 10 may use any material that is porous and exhibits a high degree of adsorption of the water repellent agent, and examples of suitable materials that can be used include honeycomb-structure ceramics, porous graphites, and porous carbon nanotubes.

Moreover, the recovery unit 58 and the trappers 66, 68 may also include an attached heating unit. When the water repellent agent trapped by the recovery unit 58 is returned to the water repellent agent storage tank 42, the attached heating unit is preferably used to heat the recovery unit 58, thereby converting the water repellent agent that is trapped inside the recovery unit to a more fluid liquid or gaseous state. Furthermore, when the water repellent agent trapped by the trappers 66, 68 is re-supplied to the FC stack, the attached heating units are preferably used to heat the trapper 66, 68, thereby converting the water repellent agent that is trapped inside the trappers to a more fluid liquid state.

The above description focuses mainly on the introduction of a water repellent agent to the cathode side where reaction water is generated, but the present invention is not limited to this configuration, and a configuration in which a fuel gas supply unit introduces a water repellent agent to the anode side in the same manner as that shown in FIGS. 1 and 3 is also possible.

The present invention has been described in detail above, but the scope of the present invention is not limited by the above description.

Furthermore, this application claims priority on Japanese Patent Application No. 2005-096426, filed on Mar. 29, 2005, and Japanese Patent Application No. 2005-096428, filed on Mar. 29, 2005, which are incorporated herein by reference in their entirety.

### INDUSTRIAL APPLICABILITY

A fuel cell system of the present invention is effective within any application that uses a fuel cell, and is particularly applicable to fuel cells designed for use within vehicles.

1. A fuel cell system, comprising a fuel cell having cells composed of an assembly having a fuel electrode and an air electrode on an electrolyte film and a separator that is laminated to the assembly, wherein
the fuel cell has a drainage additive supply unit that supplies a drainage additive for improving the drainage properties within the cells,
the drainage additive is a water repellent agent that is supplied into a reaction gas supply passage provided inside the cells of the fuel cell in order to impart water repellency to the reaction gas supply passage, and
the drainage additive supply unit is a water repellent agent supply unit that supplies the water repellent agent.

2. A fuel cell system, comprising a fuel cell having cells composed of an assembly having a fuel electrode and an air electrode on an electrolyte film and a separator that is laminated to the assembly, and
a reaction gas supply unit that supplies a reaction gas to the fuel cell, wherein
the fuel cell system further comprises a drainage additive supply unit that supplies a drainage additive for improving the drainage properties within the cells to the reaction gas supplied by the reaction gas supply unit,
the drainage additive is a water repellent agent that is supplied into a reaction gas supply passage provided inside the cells of the fuel cell in order to impart water repellency to the reaction gas supply passage, and
the drainage additive supply unit is a water repellent agent supply unit that supplies the water repellent agent.

3. The fuel cell system according to claim 1,
further comprising a monitor that monitors a usage state of the fuel cell, wherein
the drainage additive is supplied to the fuel cell by the drainage additive supply unit in accordance with a usage state of the fuel cell detected by the monitor.

4. The fuel cell system according to claim 1, further comprising
an exhaust gas passage that carries exhaust gas discharged from the fuel cell, and
a recovery unit that is provided within the exhaust gas passage and recovers the drainage additive.

5. The fuel cell system according to claim 1, wherein
the drainage additive supply unit supplies the drainage additive to a cathode side where the air electrode is located.

6.-11. (canceled)

12. The fuel cell system according to claim 4, wherein
the recovery unit is a trapping unit that is provided within the exhaust gas passage and traps the water repellent agent.

13. The fuel cell system according to claim 4, wherein
the recovery unit comprises a first trapping unit that is provided within the exhaust gas passage and traps the water repellent agent,
a second trapping unit that is provided within the reaction gas supply passage and is capable of trapping the water repellent agent, and
a gas passage switching unit which, based on quantities trapped by the first trapping unit and the second trapping unit, selects and then switches a supply passage for the reaction gas to either one of the reaction gas supply passage and the exhaust gas passage.

14. The fuel cell system according to claim 1, wherein
the water repellent agent is at least one material selected from the group consisting of saturated fatty acids, unsaturated fatty acids, silicon resin powders, paraffins, waxes, fluororesin powders, and creosote oils.

15. The fuel cell system according to claim 2,
further comprising a monitor that monitors a usage state of the fuel cell, wherein
the drainage additive is supplied to the fuel cell by the drainage additive supply unit in accordance with a usage state of the fuel cell detected by the monitor.

16. The fuel cell system according to claim 2, further comprising
an exhaust gas passage that carries exhaust gas discharged from the fuel cell, and
a recovery unit that is provided within the exhaust gas passage and recovers the drainage additive.

17. The fuel cell system according to claim 3, further comprising
an exhaust gas passage that carries exhaust gas discharged from the fuel cell, and
a recovery unit that is provided within the exhaust gas passage and recovers the drainage additive.

18. The fuel cell system according to claim 2, wherein
the drainage additive supply unit supplies the drainage additive to a cathode side where the air electrode is located.

19. The fuel cell system according to claim 3, wherein
the drainage additive supply unit supplies the drainage additive to a cathode side where the air electrode is located.

20. The fuel cell system according to claim 4, wherein
the drainage additive supply unit supplies the drainage additive to a cathode side where the air electrode is located.

21. The fuel cell system according to claim 5, wherein
the recovery unit is a trapping unit that is provided within the exhaust gas passage and traps the water repellent agent.

22. The fuel cell system according to claim 5, wherein
the recovery unit comprises a first trapping unit that is provided within the exhaust gas passage and traps the water repellent agent,
a second trapping unit that is provided within the reaction gas supply passage and is capable of trapping the water repellent agent, and
a gas passage switching unit which, based on quantities trapped by the first trapping unit and the second trapping unit, selects and then switches a supply passage for the reaction gas to either one of the reaction gas supply passage and the exhaust gas passage.

23. The fuel cell system according to claim 2, wherein
the water repellent agent is at least one material selected from the group consisting of saturated fatty acids, unsaturated fatty acids, silicon resin powders, paraffins, waxes, fluororesin powders, and creosote oils.

24. The fuel cell system according to claim 5, wherein
the water repellent agent is at least one material selected from the group consisting of saturated fatty acids, unsaturated fatty acids, silicon resin powders, paraffins, waxes, fluororesin powders, and creosote oils.

25. The fuel cell system according to claim 12, wherein
the water repellent agent is at least one material selected from the group consisting of saturated fatty acids, unsaturated fatty acids, silicon resin powders, paraffins, waxes, fluororesin powders, and creosote oils.

26. The fuel cell system according to claim 13, wherein
the water repellent agent is at least one material selected from the group consisting of saturated fatty acids, unsaturated fatty acids, silicon resin powders, paraffins, waxes, fluororesin powders, and creosote oils.
